(19) United States
(12) Patent Application Publication
(10) Pub. No.: US 2018/0157676 A1
(43) Pub. Date: Jun. 7, 2018

(54) MANAGING ACTIVITY DATA RELATED TO COLLABORATIVELY EDITED ELECTRONIC DOCUMENTS

(71) Applicant: Microsoft Technology Licensing, LLC, Redmond, WA (US)

(72) Inventors: Douglas Milvaney, Somerville, MA (US); William Tierney, Swampscott, MA (US); Kristen Tardito, Lynnfield, MA (US); Jerry Shekhel, Swampscott, MA (US); Feng Liu, Winchester, MA (US); Manish Shukla, Lexington, MA (US)

(21) Appl. No.: 15/367,130

(22) Filed: Dec. 1, 2016

(51) Int. Cl. G06F 17/30; H04L 29/08

(52) U.S. Cl. CPC G06F 17/30203; H04L 67/1097; G06F 17/30303; G06F 17/30011

(57) ABSTRACT

An end user application stores activity data in a part of an electronic document. When the electronic document is stored on a shared storage system, activity data is extracted and stored in an activity store. After activity data has been successfully stored in the activity store, the end user application can remove the activity data from the electronic document. In particular, the end user application can periodically query the activity store to identify activities that have been successfully stored in the activity store. By removing the activity data from the electronic document, the electronic document can be maintained at a reasonable size. By having the end user application remove the activity data, coherency of the data file, and consistency between local copies on end user computers and copies on the shared storage system, can be maintained.

### BACKGROUND

The availability of shared storage systems for electronic documents has increased the ability of computer end users to share and to collaborate in the creation of a variety of electronic documents. End users can cause electronic documents to be stored in a shared storage system that is accessible on a computer network, such as the internet. End users can instruct such a shared storage system to allow electronic documents to be shared with other end users of the shared storage system. A shared storage system generally has an access control component in a file system that tracks, for each electronic document, access rights that different end users have for the electronic document.

After an electronic document has been shared among two or more end users, the shared storage system manages access to the shared electronic document to ensure consistency of the electronic document, especially in the case of collaborative editing of, i.e., collaborative modifications to, the electronic document. In some implementations, a collaboration system works with the shared storage system to manage collaborative editing by tracking which end users currently are using end user applications on client computers to access the same electronic document. The collaboration system typically is implemented as one or more computer programs executing on one or more server computers, and, in some implementations, may have components executing on the client computers.

An end user application running on a computer, for the purpose of modifying electronic documents, typically is configured to allow an editor to perform a variety of actions related to electronic documents. For example, an end user may take actions with respect to an electronic document, such as opening, saving, printing, presenting, closing or sharing an electronic document, and so on. As another example, an end user may take actions that modify the electronic document, thus modifying either its structure or content or both, such as creating, deleting or updating structure and/or content. As another example, a user may take actions with respect to comments in an electronic document, such as adding, editing, or deleting a comment, replying to a comment, or marking a comment as resolved or unresolved. Adding a comment can involve associating a comment with a location within the electronic document or within a general comment section of the electronic document. Any single editor may add multiple comments to an electronic document. When the electronic document is shared, such comments can originate from multiple editors using multiple end user applications.

End users and applications can also take actions related to electronic documents outside of the collaborative editing system. For example, actions may be taken by or through a shared storage system or by or through a communication application. For example, through the shared storage system, a user may take an action with respect to an electronic document, such as deleting, sharing, renaming, moving, or copying it, or changing its permissions, and the like. As another example, a communication application may transmit a copy of an electronic document, or save an electronic document. Yet other applications may access an electronic document, such as for reading and/or printing.

Tracking information about the actions performed by end users in collaboration systems, with a large number of end users and a large number of electronic documents, can result in a large amount of data being stored about user activity.

### SUMMARY

This Summary is provided to introduce a selection of concepts in a simplified form that are further described below in the Detailed Description. This Summary is intended neither to identify key or essential features, nor to limit the scope, of the claimed subject matter.

A computer system manages storage of activity data by implementing a protocol among the shared storage system and the end user applications which reduces the amount of data stored. With this protocol, an end user application stores activity data in a part of an electronic document. When the electronic document is stored on a shared storage system, activity data is extracted and stored in an activity store. After activity data has been successfully stored in the activity store, the end user application can remove the activity data from the electronic document. In particular, the end user application can periodically query the activity store to identify activities that have been successfully stored in the activity store. By removing the activity data from the electronic document, the electronic document can be maintained at a reasonable size. By having the end user application remove the activity data, coherency of the data file, and consistency between local copies on end user computers and copies on the shared storage system, can be maintained.

In the following description, reference is made to the accompanying drawings which form a part hereof, and in which are shown, by way of illustration, specific example implementations. Other implementations may be made without departing from the scope of the disclosure.

### BRIEF DESCRIPTION OF THE DRAWINGS

FIG. 1 is a block diagram of an example computer system configured to support collaborative editing of electronic documents through end user applications on multiple client computers.

FIG. 2 is a diagram of an illustrative example of data structures for storing comment data and activity data for an electronic document.

FIG. 3 is an illustration of an example graphical user interface for displaying comment data and activity data for an electronic document in an end user application.

FIG. 4 is a data flow diagram of an illustrative example of a client computer configured to edit electronic documents.

FIG. 5 is a data flow diagram of an illustrative example of components implementing a protocol among a shared storage system and an end user application.

FIG. 6 is a flowchart of operation of an example implementation of saving activity data as performed by an end user application.

FIG. 7 is a flowchart of operation of an example implementation of a save operation as performed by the shared storage system.

FIG. 8 is a flowchart of operation of an example implementation of storing server-side activity data in an activity store.

FIG. 9 is a flowchart of operation of an example implementation of storing document-related activities by the end user application.

FIG. 10 is a flowchart of operation of an example implementation of an end user application for generating a graphical user interface.

FIG. 11 is a flowchart of operation of an example implementation of purging activities from the electronic document after successful storage of activity data in the activity store.

FIG. 12 is a block diagram of an example computer.

### DETAILED DESCRIPTION

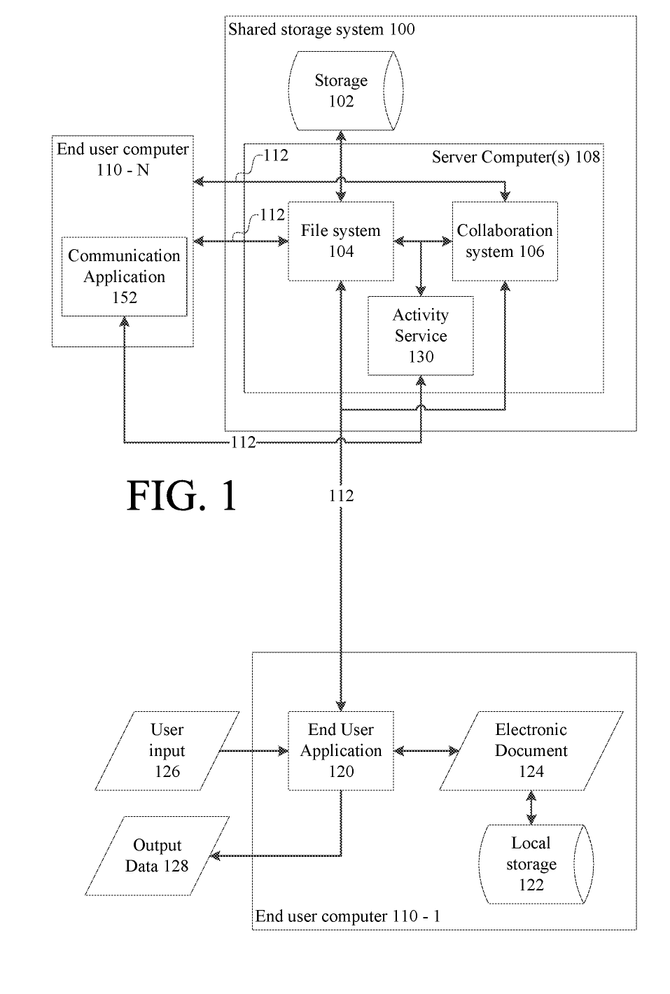

FIG. 1 is a block diagram of an example computer system configured to support sharing of electronic documents among end users, and collaborative editing of electronic documents by multiple end users through end user applications on multiple client computers, and which tracks activity data for end users related to those electronic documents.

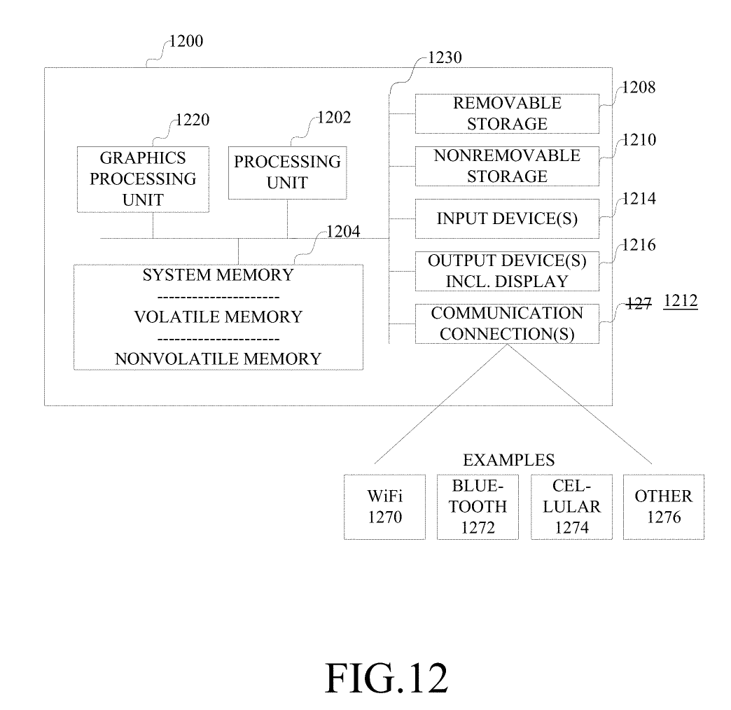

Such a computer system can include a shared storage system 100. The shared storage system 100 generally includes storage 102 in which data is stored in data files on a computer storage device accessible through a file system 104 that is part of the shared storage system. The file system configures one or more server computers 108 to store and maintain information about each file stored in the storage 102. The shared storage system 100 can be implemented using one or more general purpose computers, such as described in connection with FIG. 12, configured to implement one or more server computers. The shared storage system 100 is responsive to requests from end user computers 110 over one or more computer network(s) 112 to access, through the file system 104, files on the storage 102.

Multiple end user computers 110-1 to 110-N, also called client computers herein, are connected to the shared storage system for communication over one or more computer networks 112, such as the internet or a private computer network. An end user computer 110 can be implemented using a general purpose computer, such as described in connection with FIG. 12, configured as a client computer running one or more end user applications 120, a communication application 152 or yet other applications (not shown). Examples of such a computer include, but are not limited to, a tablet computer, a slate computer, a notebook computer, a desktop computer, a virtual desktop computer hosted on a server computer, a handheld computer, game console, and a mobile phone including a computer and applications.

The computer network(s) 112 can be any computer network supporting interaction between the end user computers and the shared storage system, such as a local area network or a wide area network, whether private and/or publicly accessible, and can include wired and/or wireless connectivity. The computer network can be implemented using any of a number of available network communication protocols, including but not limited to Ethernet and TCP/IP.

An end user computer 110 can include one or more end user applications 120. In this context, an end user application is a computer program executed on the end user computer that configures the computer to be responsive to user input 126 to allow an end user to interactively modify an electronic document 124. An electronic document can include any kind of data, such as text, still images, video, or audio and combinations of these, and generally has data defining structure of the electronic document and data defining content of the electronic document within the defined structure. The end user application processes the electronic document in response to user input received from input devices. For example, the end user application combines data to create the structure and content of the electronic document. The end user application also displays or otherwise presents output data 128, such as a graphical user interface including the content according to the structure of the electronic document, through output devices (not shown) to the end user. The end user application also stores the electronic document in memory and/or in a data file in local storage 122 of the end user computer and/or in the shared storage system 100.

A variety of kinds of end user applications can be used on an end user computer. Examples of an end user application include, but are not limited to, a word processing application, a presentation application, a note taking application, a text editing application, a paint application, an image editing application, a spreadsheet application, a desktop publishing application, a drawing application, a video editing application, and an audio editing application. An end user application can permit a variety of operations on an electronic document, such as, but not limited to, viewing and commenting without content editing, viewing and content editing, or viewing only.

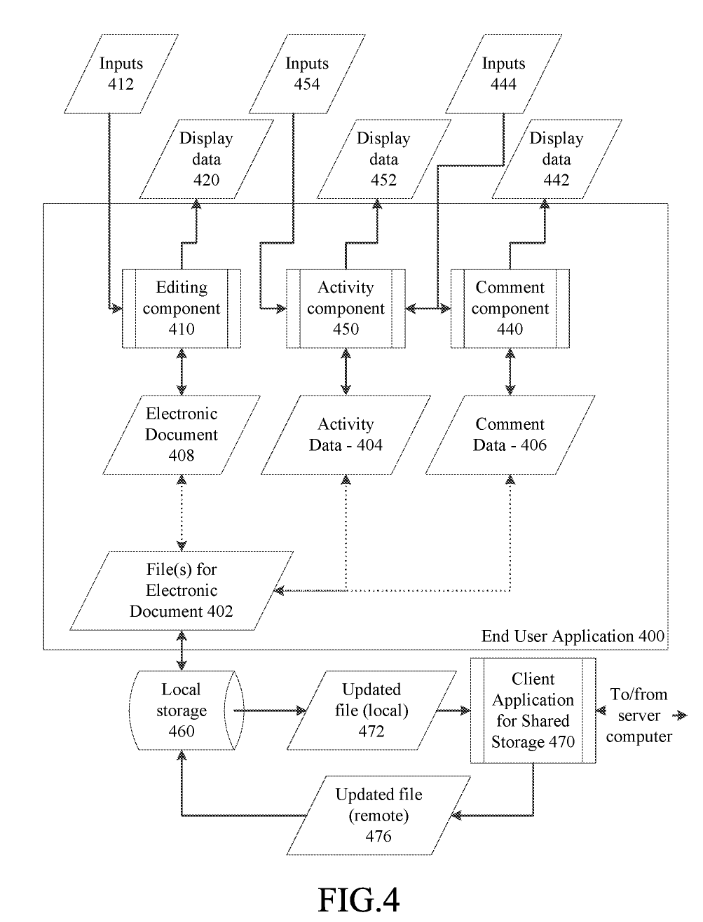

As noted above, an end user application 120 generates an electronic document 124 that is stored in a data file, which can be stored in local storage 122 and/or the shared storage system 100. The electronic document, while being modified by an end user on the end user computer, also is temporarily stored in memory on the end user computer. The end user application also may temporarily store the electronic document in a cache on local storage before committing changes to the electronic document to the data file. The client computer may have an application that coordinates with the shared storage system 100 to save the electronic document on the shared storage system 100, an example of which is described in more detail below in connection with FIG. 4.

For an electronic document stored in a data file in a shared storage system 100, the file system 104 of the shared storage system can include information indicating a sharing state of the electronic document. Such information can be in the form of access controls indicating which end users are authorized to access the electronic document and its related data.

The file system 104 also can be configured to be responsive to a query to provide this information to another application associated with the shared storage system, such as a collaboration system 106 or an activity service 130 or other service on the shared storage system, or applications on end user computers, such as an end user application 120, a communication application 152, or other application. The file system 104 also can provide a mechanism to change the sharing state of an electronic document, either directly through the shared storage system or indirectly through another application, in a number of ways.

In some implementations, electronic documents also can be shared by users by distributing a copy of the electronic document through various distribution channels among multiple users. Such sharing generally involves an application accessing the electronic document through the file system 104 to obtain either a copy of the electronic document or a resource identifier, such as a uniform resource identifier or file name, for accessing the electronic document through the shared storage system 100.

In some implementations, when an electronic document stored in the shared storage system is shared, with modification rights, with multiple end users, two or more end user applications on two or more client computers can access and can attempt to modify the electronic document through the shared storage system 100. To handle such a condition, the shared storage system can include a collaboration system 106. The collaboration system 106 is a computer program that configures the server computer to manage contemporaneous access to shared electronic documents in the shared storage system 100. The collaboration system 106 can store information about end user applications, and associated end users, that currently are accessing the electronic document.

Using the information about end user applications and end users currently accessing an electronic document, the collaboration system can implement any of a number of different techniques for coordinating access to the electronic document to ensure consistency of the electronic document. For example, the collaboration system can prevent one end user application from causing modifications to be written to a data file for an electronic document while another the data file is open for writing by another end user application. As another example, the collaboration system can interactively merge changes to the electronic document as such changes are being made collaboratively through multiple end user applications. In such a case, as an example, the collaboration system can merge changes received from end user computers in memory local to the collaboration system, and then can transmit a modified version of the electronic document to each end user computer with an application currently accessing the document.

The end user application 120 running on an end user computer 110, for the purpose of modifying electronic documents, typically is configured to allow an editor to perform a variety of actions related to electronic documents. Generally, each user can modify the electronic document, possibly adding comments to the electronic document and performing other actions with respect to the document, and then can share the modified electronic document with additional users. For example, an end user may take actions with respect to an electronic document, such as opening, saving, printing, presenting, closing, or sharing an electronic document, and so on. As another example, an end user may take actions that modify the electronic document, thus modifying either its structure or content or both, such as creating, deleting or updating structure and/or content, and/or updates to activity data associated with the electronic document. As another example, a user may take actions with respect to comments in an electronic document, such as adding, editing, or deleting a comment, replying to a comment, or marking a comment as resolved or unresolved. Adding a comment can involve associating a comment with a location within the electronic document or within a general comment section of the electronic document. Any single editor may add multiple comments to an electronic document. When the electronic document is shared, such comments can originate from multiple editors using multiple end user applications.

End users and applications can also take actions related to electronic documents outside of the collaborative editing system. For example, actions may be taken by or through a shared storage system or by or through a communication application. For example, through the shared storage system, a user may take an action with respect to an electronic document, such as deleting, sharing, renaming, moving, or copying it, or changing its permissions, and the like. As another example, a communication application may transmit a copy of an electronic document, or save an electronic document. Yet other applications may access an electronic document, such as for reading and/or printing.

A communication application is a computer program executed on the end user computer that configures the computer to be responsive to user input to allow an end user to interactively receive and read, or compose and send, electronic messages. The communication application 152 and the end user application 120 used by an end user can be on different end user computers 110. The communication application can present display data (not shown), such as a graphical user interface including electronic messages, through output devices of the end user computer to the end user. An electronic message can include any kind of data, such as text, still images, video, or audio and combinations of these, and generally includes identifiers for a sender and one or more recipients of the electronic message.

A variety of kinds of communication applications can be used on an end user computer. Examples of a communication application include, but are not limited to, an electronic mail application, an instant messaging application, a chat application, a real time voice and/or video communication application, or other application that can provide messages to an end user on the end user computer.

As multiple end users use an electronic document, the activity data associated with that electronic document can grow significantly. Storing all activity data over time for an electronic document can result in high utilization of many resources, including but not limited to processing, storage, bandwidth and power, by the end user application, by intermediate devices that process electronic documents, networking equipment, and the shared storage system.

A computer system manages storage of activity data by implementing a protocol among the shared storage system and the end user applications which reduces the amount of data stored.

An example implementation of such a protocol will be described further below, after a description of an example operating environment, including a collaborative editing system, in which the protocol can be used.

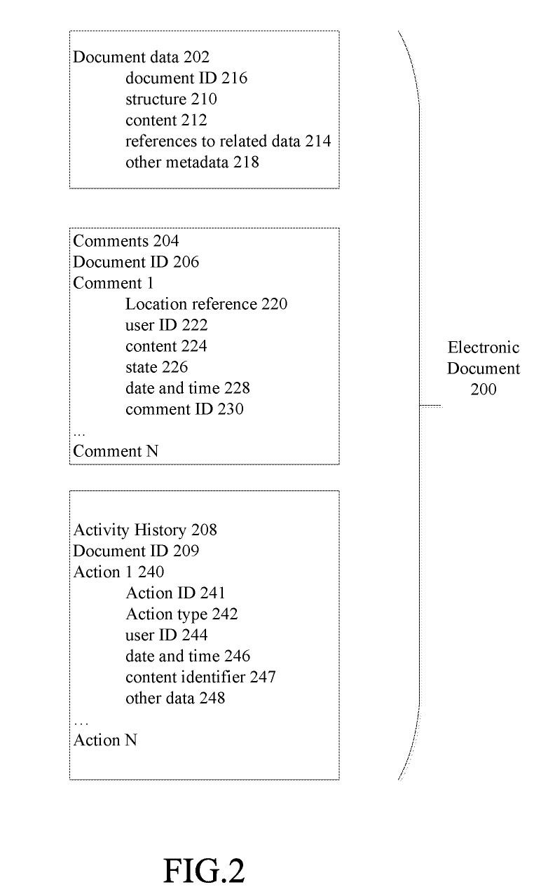

A particular example implementation of the shared storage system, collaborative editing system, and corresponding end user application, will now be described in connection with FIGS. 2-4. It should be understood that this is just one example implementation, and that many other implementations are possible. This example illustrates an end user application that generates activity data and comment data in response to user input, including data structures, graphical user interface and application architecture supporting communication of such data to both the shared storage system and the end user. This is one example implementation of a context in which a protocol for managing activity data can be implemented.

The data representing an electronic document can be stored in computer storage in a number of different formats. On the one hand, there can be a file format for one or more data files for storing data for an electronic document in persistent storage. On the other hand, there can be one or more data structures stored in memory for providing access to the data for the electronic document by an end user application during editing or viewing of the electronic document. The file format can be and typically is different from the data structure that is stored in memory, yet both store essentially the same data.

An example implementation of data representing an electronic document will now be described in connection with FIG. 2. In FIG. 2, in general, and whether in a data file in persistent storage or data structure in memory, the data 200 for the electronic document includes document data 202, representing structure and content of the electronic document, comment data 204, representing structure and content of comments, and activity data 208 representing actions related to the electronic document taken by end users.

With respect to an example file format, in one implementation, the document data 202 and the comment data 204 can be stored in one data file, and activity data 208 can be stored in a separate second data file. Comment data, in one implementation, can be stored within the electronic document data file, for example as a stream of data within the data file. In this implementation, the data defining the structure and content of the data file can be stored as a separate stream within the data file. In another implementation, the document data 202, the comment data 204, and the activity data 208 all can be stored in a single data file. In another implementation, the document data 202, the comment data 204, and the activity data 208 each can be stored in separate data files or other data storage such as a database. By storing comment data, activity data and other types of data within the same file as the electronic document, such data can be transmitted with the electronic document through other channels to other users. When such data is stored separately, access controls also can be applied separately to such data. For example, access controls can be applied to such data so that only users, with whom the electronic document is shared in a shared storage system with access rights, have access to the additional comment data, activity data or other types of data. For example, this additional data can be stored in a database, for example in a key-value pair format, such as a JavaScript Object Notation (JSON) or similar format.

When such data (as shown in FIG. 2) is read by an application, such as an end user application or a communication application, the application may generate corresponding data structures in memory. In the end user application, such data in the data structures can be modified in memory in response to user actions. The end user application in turn processes and stores the data structures into the data files at periodic intervals and/or in response to an instruction received from an end user.

Generally speaking, the document data 202 for the electronic document includes a document identifier 216, data defining the structure 210 of the electronic document, and data defining the content 212 within that structure of the electronic document. There is a wide variety of formats for electronic documents, including various markup languages, such as the hypertext markup language (HTML), standard generalized markup language (SGML), extensible markup language (XML), as well as proprietary document formats. The invention is not limited to any particular format for the structure and content of the electronic document. The data for an electronic document may include references to other data related to the electronic document 214, such as files storing comment data, activity data, style sheets for formatting the document, templates, macros and the like. The data for an electronic document also may include various metadata 218 about the electronic document.

Comment data 204 defining a collection of comments can include a document identifier 206 indicating the electronic document to which the collection of comments is related. The comment data can include, for each comment, a reference 220 to a location within the electronic document, a user identifier 222 of the end user that added the comment, and content 224 of the comment, which is typically text but is not limited to text. The reference 220 to a location in a document can be, for example, an offset within the electronic document, such as an offset within the content associated with a structural element of the electronic document. The user identifier can be any indication of a user, such as an email address, user name, etc., such as the user name for the user to access the shared storage system that stores the electronic document. State information 226 also can be associated with a comment, such as data indicating whether the comment has been resolved. A comment also can have an associated date and time stamp 228 indicating when the comment was added to the electronic document. The comment can have a comment identifier 230 that distinguishes the comment from other comments associated with the electronic document.

Comments can be threaded, such that a comment refers to another comment, perhaps in the form of a reply. There are a variety of ways to implement comment threading, such as using the reference 220 of a first comment to refer to a comment identifier 230 of another comment, or using a linked list to represent a comment and any reply comments associated with it.

Activity data 208 defining a collection of actions associated with an electronic document can include a document identifier 209 indicating the electronic document to which the collection of actions is related. The activity data can include, for action 240, an action identifier 241, data indicating a type of action 242, a user identifier 244 of the end user associated with the action, and a date and time stamp 246 indicating when the action occurred. As in the comment data, the user identifier can be any indication of a user, such as an email address, user name, etc., such as the user name for the user to access the shared storage system that stores the electronic document. The type of action 242 can indicate, for example, whether the action is a type of action with respect to the electronic document, a type of action with respect structure and/or content, activity data, or comment data, or other type of action. A content identifier 247 also can be included to identify a section of the electronic document to which the activity applies. Other data 248, such as text or other information, or information about the end user application being used for the action, can be stored as part of the data describing the action 240.

The activity data can represent a variety of different kinds of actions performed by users through the end user application and associated with the electronic document. Such actions can include actions with respect to an electronic document, for example, opening, saving, printing, presenting, closing or sharing an electronic document, and so on. As another example, an end user may take actions that modify the electronic document, thus modifying either its structure or content or both, such as creating, deleting or updating structure and/or content, and/or updates to activity data associated with the electronic document. An action also can be associated with a location within the document, such as a comment, such as adding, editing, or deleting a comment, replying to a comment, or marking a comment as resolved or unresolved. A mention of another individual also can be associated with a location in the document, which is another form of content-related activity. Actions also can include other types of actions, such as messages between or among users associated with the electronic document, which are not associated with any particular location in the electronic document. Such actions, e.g., messages, are another form of document-related activity. When the activity data is stored separately from the electronic document, the activity service 130 can store activity data from other sources as well, such as from the file system or other applications not interacting through the collaborative editing system. In such a case, the activity data can represent a larger range of possible actions related to a document.

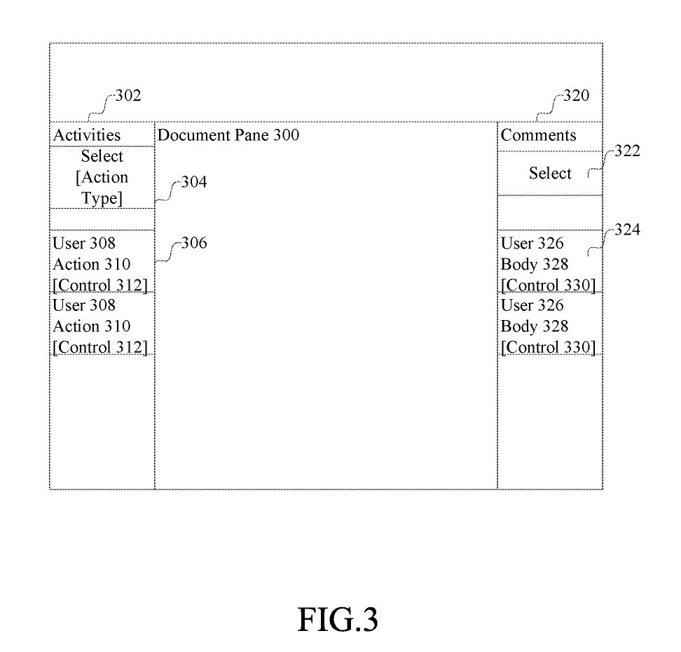

In FIG. 3, an example graphical user interface for an end user application is shown. In this example graphical user interface, a document pane 300 is a primary display area in which the electronic document is presented on a display. The end user computer receives user inputs through one or more input devices, and can associate such inputs with operations with respect to the electronic document in document pane 300, or with respect to other graphical elements in the graphical user interface. The end user computer processes some user inputs to effect modifications to the structure and/or content of the electronic document currently being accessed in the document pane 300.

The graphical user interface for the end user application can include an activity pane 302 in which the end user application displays activity data associated with the electronic document. In response to user input, various settings can be provided that control the display of the activity data. In the activity pane, activity data representing an action is displayed by generating a graphical representation 306 of the action including an indication 308 of the user that performed the action, which can include a name, user name and/or picture of the user, and a body 310 of the action, which is typically text, but can include other data describing the action as well as other visual appearance parameters related to the action. This graphical representation 306 of an action can be generated using a variety of data accessible through the activity data describing the action. Graphical elements in the graphical representation of the action can include one or more controls 312, such as buttons, that allow an end user to provide input with respect to a displayed action. The invention is not limited to any particular kind of display of the activity data.

The graphical user interface for the end user application can include a comments pane 320 in which the end user application displays one or more comments associated with the electronic document. In response to user input, various settings can be provided that control the display of the comment data. In the comments pane, a comment is displayed by generating a graphical representation 324 of the comment including an indication 326 of the user that created the comment, which can include a name, user name and/or picture of the user, and the body 328 of the comment, which is typically text but can include other data, as well as other visual appearance parameters related to the comment. This graphical representation 324 of a comment can be generated using a variety of data accessible through the data for the comment. Graphical elements in the graphical representation of the comment can include one or more controls 330, such as buttons, that allow an end user to provide input with respect to a displayed comment. The invention is not limited to any particular kind of display of the comment data. The display of the comment data also can be integrated with the display of the structure and content of the electronic document in the document pane.

The activity pane and comments pane also can be implemented using other graphical user interface techniques. A modal dialog box, a call-out interface, or small pop-up window, also are examples of a kind of interface that can be shown in the context of the currently accessed electronic document.

FIG. 4 is a data flow diagram of an example implementation of an end user application 400, running on a client computer, which includes a comment pane and an activity pane such as shown in FIG. 3. It should be understood that the implementation as described in connection with FIGS. 3 and 4 is merely an example implementation of an end user application and that a wide variety of other implementations are possible. The end user application 400 has an input to receive one or more files 402 and/or other data defining the electronic document. The end user application generates, in memory, representations of activity data 404 as data representing a collection of actions, and comment data 406 as data representing a collection of comments, based on the received one or more files.

The files 402 may be received from local storage 460 and/or from a shared storage system (such as 100 in FIG. 1). In many shared storage systems, the files in local storage 460 are synchronized with copies of the files on a server computer in the shared storage system. For example, the end user computer can include a client application 470 for shared storage that periodically transmits an updated file 472 of the electronic document from the local storage 460 to the server computer. The server computer then transmits a copy of the electronic document received from one client computer to the other client computers that are using that electronic document. The client application 470 for the shared storage receives an updated file 476 of the electronic document from the server computer, and then updates the copy in local storage 460.

The client application 470 can implement a client-side of the protocol with the shared storage system to manage the activity data. The activity service (FIG. 1) on the shared storage system can implement the server side of the protocol.

The end user application also processes the structure and content of the electronic document into memory to generate a representation of the electronic document 408, which is edited through an editing component 410. The editing component has inputs to receive user and system inputs 412 involved in the editing and storing of the electronic document, and outputs to provide display data 420 representing the electronic document being edited, and outputs to provide a modified electronic document back to storage as a file 402 upon saving. The end user application displays the display data 420 through a graphical user interface, which can include one or more displays and/or other output devices.

A comment component 440 manages interaction with the comment data 406. For example, the comment component generates display data 442 for a comment pane to be displayed in the graphical user interface 416 using the comment data 406. Also, the comment component can be responsive to inputs 444, such as adding a comment, deleting a comment, editing a comment, replying to a comment and resolving a comment, to update the comment data 406. The comment component also can interactively update the display of the comments in response to updates to the comment data and/or user input.

An activity component 450 manages interaction with the activity data 404. For example, the activity component generates display data 452 for an activity pane to be displayed in the graphical user interface using the activity data 404. Also, the activity component can be responsive to inputs 454, for actions with respect to the electronic document and with respect to the structure, content and activity data of the electronic document, and other inputs 444 for actions related to content, such as comments and mentions, to update the activity data for the electronic document. The activity component 450 also can interactively update the display of the actions in response to updates to the activity data and/or user input.

It should be understood that the foregoing is just one example implementation of a collaborative editing system in which actions related to electronic documents are stored, in a way that relates them to the electronic document. Implementations of such systems will vary at least in the type of data stored, in the manner in which such data is stored, and in how such data is collected from end user applications, and yet other applications such as communication applications and the shared storage system.

Given the foregoing example implementation of an operating context for a protocol for managing activity data, the following is an example implementation of how such a protocol can be implemented by an end user application and an activity service of the shared storage system to reduce processing, storage and transmission of activity data.

Generally speaking, with this protocol, an end user application stores activity data in a part of an electronic document. When the electronic document is stored on a shared storage system, activity data is extracted and stored in an activity store. After activity data has been successfully stored in the activity store, the end user application can remove the activity data from the electronic document. In particular, the end user application can periodically query the activity store to identify activities that have been successfully stored in the activity store. By removing the activity data from the electronic document, the electronic document can be maintained at a reasonable size. By having the end user application remove the activity data, coherency of the data file, and consistency between local copies on end user computers and copies on the shared storage system, can be maintained.

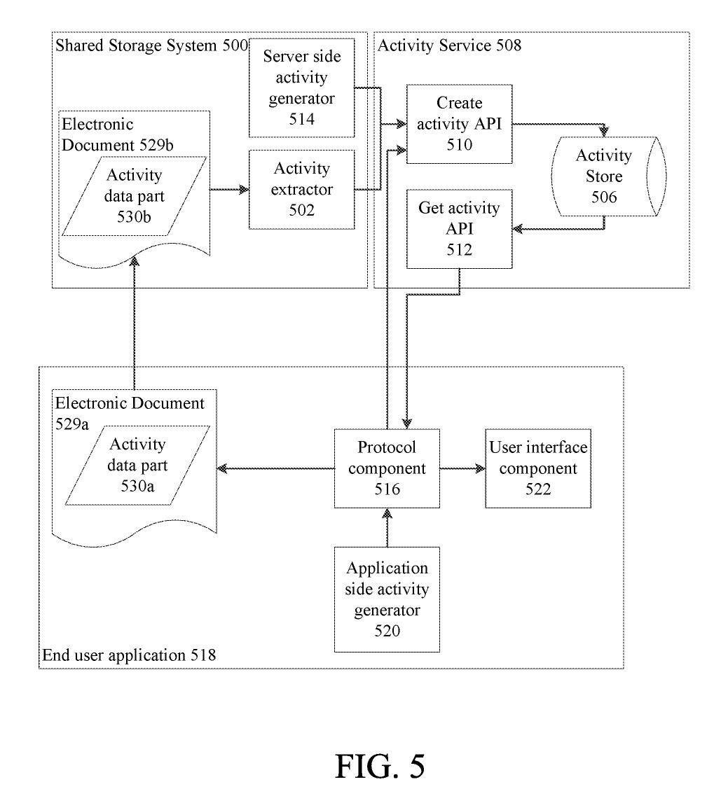

Turning now to FIG. 5, a dataflow diagram of an example implementation of the components implementing such a protocol, among the shared storage system and end user application, will now be described.

As part of the shared storage system 500, an activity extractor 502 receives activity data from an activity data part 530b from an electronic document 529b stored on the shared storage system 500. An activity extractor 502 processes the activity data to store data about individual actions in the activity store 506, which is part of an activity service 508. In this example, the activity service 508 includes a “create activity API” 510 for creating an activity in the activity store, and a “get activity API” 512 for retrieving activity data from the activity store. The activity extractor 502 can use the create activity API 510 to add one or more entries to the activity store 506. The data in the activity store can include, for each activity, the same data as shown in FIG. 2, for example.

Other activity data that is not passed through the electronic document also can be stored in the activity store through the create activity API 510. For example, file system actions from the shared storage system 50 can be stored by a server side activity generator 514. Similarly, a protocol component 516 of an end user application 518 (on an end user computer) can store activity data directly in the data store (for example, for activity data which is not passed through the data file, such as document-related activities performed on the end user computer).

In the end user application 518, the protocol component 516 manages storing activity data related to content of the electronic document in a local copy of the activity data part 530a of the data file for the electronic document 529a. Such activity data generally is application specific, meaning each end user application generally has its own application side activity generator 520 which generates activity data in response to user input. An end user application 518 is programmed to use the protocol component 516; the application side activity generator 520 of the end user application provides information about activities, such as action types and other data, to the protocol component 516. The protocol component 516 can be responsible for creating unique activity identifiers within an electronic document for each activity generated for that electronic document; however, the end user application 518 can provide identifiers for different action types that can be created by that end user application.

This protocol component 516 also can provide activity data to a user interface component 522, to generate a graphical user interface with activity data (such as in FIG. 3).

This protocol component also is responsible for periodically removing activity data from the local copy of the activity data part 530b of the data file 529b for the electronic document. To do so, the protocol component 516 accesses the activity store 506 through get activity API 512 of the activity service 508 to access the activity data that has been extracted and stored by the activity extractor 502 in the activity 506 for a particular electronic document.

Example implementations of different operations implementing this protocol will now be described.

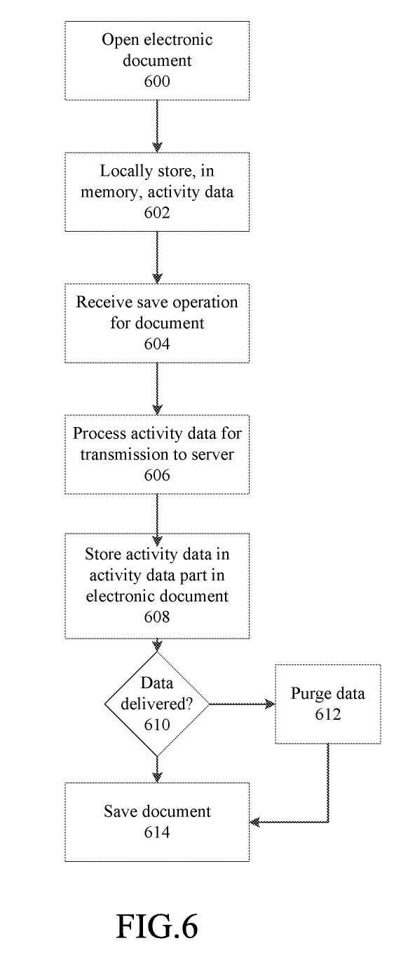

FIG. 6 is a flowchart of operation of an example implementation of saving activity data as performed by an end user application. The end user application first opens 600 an electronic document. The end user application starts, either on its own or through APIs of the protocol component 516, locally storing (602), in memory, activity data in response to user input with respect to the document. When storing the activity data, the end user application may request activity identifiers for the activities being stored.

In response to a save operation (604), whether in response to user input or an automatic save, the protocol component processes 606 the activity data for transmission to the server. For example, activity data can be stamped with a document identifier and user identifier if such information was not available prior to the save operation. Such a case can arise when the end user application is being used on a locally stored document and the end user logs into the server at the time of the save operation. At this time, the server may provide the end user application a document identifier and a user identifier. The activity data is then stored 608 in the activity data part of the electronic document, and the electronic document can be saved 614, which can cause the file to be stored on both local storage and shared storage when using an implementation such as shown in FIG. 4.

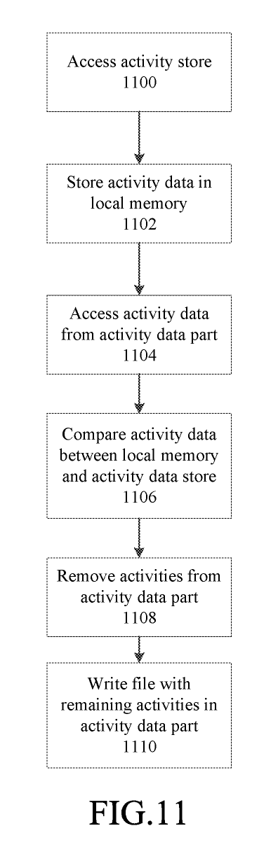

Prior to saving the electronic document (at 614), the protocol component can opportunistically purge any old activity data from the electronic document. In particular, if activity data already exists in the activity data part, as determined at 610, then the protocol component can purge 612 some the activity data. The operation of purging activity data is described in more detail below in connection with FIG. 11. While the purging is described here as occurring before the electronic document is stored locally and on the server with new activity data, and in response to invoking the save operation, such purging also can occur after the save operation, or periodically and automatically in a manner similar to an auto-save operation.

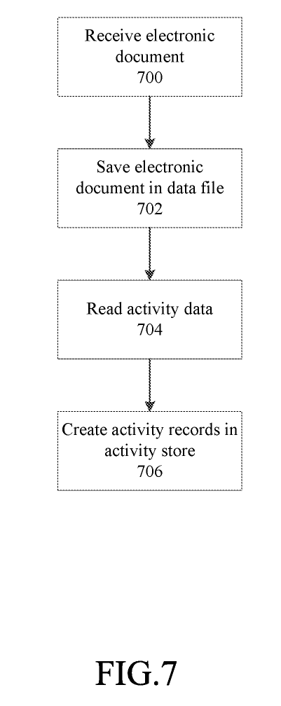

FIG. 7 is a flowchart of operation of an example implementation of a save operation as performed by the shared storage system. The shared storage system receives 700 an electronic document from an end user computer as part of a save operation occurring at the end user computer, such as in response to user instruction or upon an auto-save operation. The shared storage system saves 702 the electronic document, with the activity data, in its file store as a data file. The shared storage system also reads 704 the activity data from the data file into memory for processing into the activity store. For each activity in the activity data, the activity extractor (FIG. 5) creates 706 a record in the activity store. This record can include the activity data as found in the electronic document, and can include one or more additional fields, such as a date and time the activity was stored by the server.

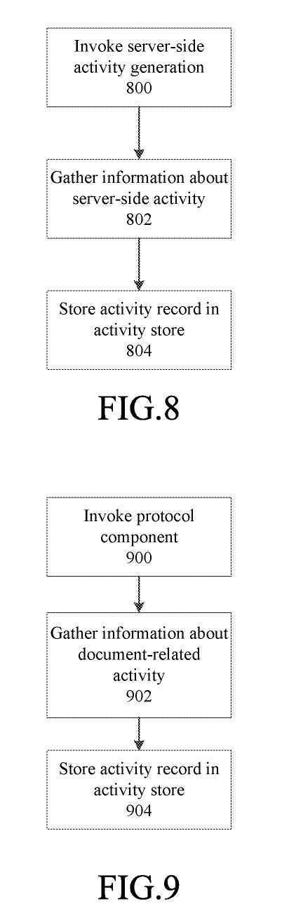

FIG. 8 is a flowchart of operation of an example implementation of storing server-side activity data in an activity store. Server-side activity data can include any of a variety of operations or actions taken upon a data file in the shared storage system, outside of the context of an end user application. Operations such as moving, renaming, copying, sharing, etc. can occur. Unlike the content-related activity data from the end user application, such activity data is not recorded in the activity data part of the electronic document. In response to such an operation, the shared storage system invokes 800 the server-side activity generation (FIG. 5). The server-side activity generation gathers (802) information for the activity, such as a document identifier, user identifier, action identifier, etc., to create an activity record. This activity record is then stored 804 in the activity store through the create activity API.

FIG. 9 is a flowchart of operation of an example implementation of storing document-related activities by an end user application. Such document-related activity data can include any of a variety of operations or actions taken upon a data file through an end user application. Such operations generally do not relate to modifications of the structure or content of the body of the electronic document or its comments. Operations such as presenting the document, printing the document, sharing the document, and the like, can occur. Unlike the content-related activity data from the end user application, such activity data is not recorded in the activity data part of the electronic document. In response to such an operation, the end user application invokes 900 the protocol component (FIG. 5). The protocol component gathers (902) information for the activity, such as a document identifier, user identifier, action identifier, etc. to create an activity record. This activity record is then stored 906 in the activity store through the create activity API.

After activity data related to the content of the electronic document is stored in the activity store, the end user application can remove such activity data from the activity data part of the electronic document. Note that other activity data with respect to the electronic document which is not originally stored in the activity data need not be removed from the activity data. Also, the end user application can use any activity data from the activity store, including activity data with respect to the electronic document which was not passed through the activity data part of the electronic document, to present a graphical user interface, such as FIG. 3, about the stored activities.

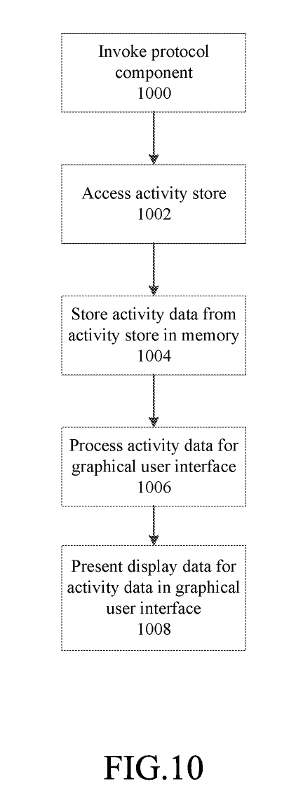

FIG. 10 is a flowchart of operation of an example implementation of an end user application for generating a graphical user interface.

The end user application invokes 1000 the protocol component to access the activity data for a specified electronic document by providing a document identifier for the document. The activity data can be initially accessed, for example, when the electronic document is first opened in the end user application. The protocol component accesses 1002 the read activity API of the activity store to retrieve activity data for the specified electronic document. The protocol component stores 1004 the read activity data in local memory of the end user computer. The data stored in the local memory can be treated as a cache, and can be periodically refreshed by the protocol component from the activity store. Given the activity data stored locally, the end user application can process 1006 the activity data into display data for a graphical user interface, such as shown in FIG. 3, and such display data can be presented 1008 in the graphical user interface.

The activity data cached by the protocol component also can be used to purge activity data from the activity data part of the electronic document. FIG. 11 is a flowchart of operation of an example implementation of purging activities from the electronic document after successful storage of activity data in the activity store. As with using the activity data for a graphical user interface, the protocol component accesses 1100 the read activity API of the activity store to retrieve activity data for the specified electronic document. The protocol component stores 1102 the read activity data in local memory of the end user computer. The data stored in the local memory can be treated as a cache, and can be periodically refreshed by the protocol component from the activity store. To improve performance of the process of purging activity data from the electronic document, the protocol component accesses the activity data from the data store prior to the time when the purge operation occurs. For example, when purging is done prior to saving the document, but when the save operation is invoked, the protocol component can load the activity data from the activity store when the document is opened by the end user application, and then can periodically update the cached activity data thereafter.

The protocol component accesses 1104 the activity data part of the electronic document as it exists on the end user computer. The protocol component then compares 1106 the activity data from the activity data part to the activity data in the cache. Such a comparison can be performed in many ways, such as by iterating through the activities of the activity data part and comparing its activity identifier to the activity identifiers in the cache. Any activity in the activity data part which is found in the cached activity data can be removed 1108 from the activity data part. The remaining activity data, not purged from the activity data part, is written as the activity data part of the file for the electronic document at the next write or save operation (1110). When the electronic document is next saved, it is synchronized with other instances of the electronic document through the collaboration system, which maintains the coherency of the electronic document.

By having the activity data stored in an activity store in the shared storage system in this manner, the activity data does not cause the electronic document to continually grow in size. However, by using the saving of the electronic document as the mechanism to transport the activity data, the coherency of this information is maintained.

An additional operation that can be performed on the activity data is coalescing of activities. Thus, if multiple activities are performed on the same content, these activities can be coalesced into a single, or no, activity. For example, if a user creates a paragraph, updates the paragraph and then deletes the paragraph, then the result is as if there was no action. Activities can be coalesced, in the manner described below, if the activity data includes a content identifier for content to which an activity is related, and the activity data includes the most up-to-date data resulting from that activity. Activity coalescence can be performed by the protocol component prior to saving the electronic document, to prevent multiple activities from being stored in the activity store.

In general, content related activities involve creating, modifying or deleting a section of content. The following table is an example implementation in which a pair of activities are coalesced into a single activity, based on the data resulting from the second activity:

| First content activity | Second content activity | Resulting Activity |
|---|---|---|
| Create | Create | Create |
| Create | Update | Create |
| Create | Delete | <none> |
| Update | Create | Create |
| Update | Delete | Delete |
| Update | Update | Update |
| Delete | Create | <none> |
| Delete | Update | Create |
| Delete | Delete | Delete |

Having now described an example implementation, FIG. 12 illustrates an example of a computer with which components of the computer system of the foregoing description can be implemented. This is only one example of a computer and is not intended to suggest any limitation as to the scope of use or functionality of such a computer.

The computer can be any of a variety of general purpose or special purpose computing hardware configurations. Some examples of types of computers that can be used include, but are not limited to, personal computers, game consoles, set top boxes, hand-held or laptop devices (for example, media players, notebook computers, tablet computers, cellular phones including but not limited to “smart” phones, personal data assistants, voice recorders), server computers, multiprocessor systems, microprocessor-based systems, programmable consumer electronics, networked personal computers, minicomputers, mainframe computers, and distributed computing environments that include any of the above types of computers or devices, and the like.

With reference to FIG. 12, a computer 1200 includes a processing system comprising at least one processing unit 1202 and at least one memory 1204. The processing unit 1202 can include multiple processing devices; the memory 1204 can include multiple memory devices. A processing unit 1202 comprises a processor which is logic circuitry which responds to and processes instructions to provide the functions of the computer. A processing device can include one or more processing cores (not shown) that are multiple processors within the same logic circuitry that can operate independently of each other. Generally, one of the processing units in the computer is designated as a primary processor, typically called the central processing unit (CPU). One or more additional co-processing units 1220, such as a graphics processing unit (GPU), also can be present in the computer. A co-processing unit comprises a processor that performs operations that supplement the central processing unit, such as but not limited to graphics operations and signal processing operations.

The memory 1204 may include volatile computer storage devices (such as dynamic random access memory (DRAM) or other random access memory device), and non-volatile computer storage devices (such as a read-only memory, flash memory, and the like) or some combination of the two. A nonvolatile computer storage device is a computer storage device whose contents are not lost when power is removed. Other computer storage devices, such as dedicated memory or registers, also can be present in the one or more processors. The computer 1200 can include additional computer storage devices (whether removable or non-removable) such as, but not limited to, magnetically-recorded or optically-recorded disks or tape. Such additional computer storage devices are illustrated in FIG. 1 by removable storage device 1208 and non-removable storage device 1210. Such computer storage devices 1208 and 1210 typically are nonvolatile storage devices. The various components in FIG. 12 are generally interconnected by an interconnection mechanism, such as one or more buses 1230.

A computer storage device is any device in which data can be stored in and retrieved from addressable physical storage locations by the computer by changing state of the device at the addressable physical storage location. A computer storage device thus can be a volatile or nonvolatile memory, or a removable or non-removable storage device. Memory 1204, removable storage 1208 and non-removable storage 1210 are all examples of computer storage devices. Some examples of computer storage devices are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage devices and communication media are distinct categories, and both are distinct from signals propagating over communication media.

Computer 1200 may also include communications connection(s) 1212 that allow the computer to communicate with other devices over a communication medium.

Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal. By way of example, and not limitation, communication media includes wired media, such as metal or other electrically conductive wire that propagates electrical signals or optical fibers that propagate optical signals, and wireless media, such as any non-wired communication media that allows propagation of signals, such as acoustic, electromagnetic, electrical, optical, infrared, radio frequency and other signals.

Communications connections 1212 are devices, such as a wired network interface, wireless network interface, radio frequency transceiver, e.g., WiFi 1270, cellular 1274, long term evolution (LTE) or Bluetooth 1272, etc., transceivers, navigation transceivers, e.g., global positioning system (GPS) or Global Navigation Satellite System (GLONASS), etc., transceivers, and network interface devices 1276, e.g., Ethernet, etc., or other device, that interface with communication media to transmit data over and receive data from signal propagated over the communication media.

The computer 1200 may have various input device(s) 1214 such as a pointer device, keyboard, touch-based input device, pen, camera, microphone, sensors, such as accelerometers, thermometers, light sensors and the like, and so on. The computer 1200 may have various output device(s) 1216 such as a display, speakers, and so on. Such devices are well known in the art and need not be discussed at length here. Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye, and gaze tracking, immersive augmented reality and virtual reality systems, all of which provide a more natural interface, as well as technologies for sensing brain activity using electric field sensing electrodes (EEG and related methods).

The various computer storage devices 1208 and 1210, communication connections 1212, output devices 1216 and input devices 1214 can be integrated within a housing with the rest of the computer, or can be connected through various input/output interface devices on the computer, in which case the reference numbers 1208, 1210, 1212, 1214 and 1216 can indicate either the interface for connection to a device or the device itself as the case may be.

A computer generally includes an operating system, which is a computer program that, when executed, manages access, by other applications running on the computer, to the various resources of the computer. There may be multiple applications. The various resources include the memory, storage, input devices and output devices, such as display devices and input devices as shown in FIG. 1. To manage access to data stored in nonvolatile computer storage devices, the computer also generally includes a file system which maintains files of data. A file is a named logical construct which is defined and implemented by the file system to map a name and a sequence of logical records of data to the addressable physical locations on the computer storage device. Thus, the file system hides the physical locations of data from applications running on the computer, allowing applications to access data in a file using the name of the file and commands defined by the file system. A file system generally provides at least basic file operations such as creating a file, opening a file, writing a file or its attributes, reading a file or its attributes, and closing a file.

The various modules, tools, or applications, and data structures and flowcharts of FIGS. 1-11, as well as any operating system, file system and applications on a computer in FIG. 12, can be implemented using one or more processing units of one or more computers with one or more computer programs processed by the one or more processing units.

A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct or configure the computer to perform operations on data, or configure the computer to implement various components, modules or data structures.

Alternatively, or in addition, the functionality of one or more of the various components described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Accordingly, in one aspect, a shared storage system comprising a server computer with a network interface configured to connect the shared storage system to a computer network connected to a plurality of end user computers, a computer storage device, and a processing device. The processing device executes computer program code that configures the server computer to be comprising a file system and an activity service. The file system is operative to provide access to a plurality of electronic documents in the computer storage device. The file system is operative, in response to receiving an electronic document including an activity data part, to store the electronic document with the activity data part as a data file in the file system. The activity service is operative to extract activity data from an activity data part of an electronic document, the activity data including, for an action performed on an end user computer, an identifier of the action, an identifier of a type of the action, and an identifier of an end user. The activity service is further operative to store the activity data in an activity store on the computer storage device.

In another aspect, a computer system comprises a server computer and an end user computer connected over a computer network. The server computer includes a network interface configured to connect the shared storage system to the computer network, a computer storage device, and a processing device. The processing device executes computer program code that configures the server computer to be comprising a file system and an activity service. The file system is operative to provide access to a plurality of electronic documents in the computer storage device. The file system is operative, in response to receiving an electronic document including an activity data part, to store the electronic document with the activity data part as a data file in the file system. The activity service is operative to extract activity data from an activity data part of an electronic document, the activity data including, for an action performed on an end user computer, an identifier of the action, an identifier of a type of the action, and an identifier of an end user. The activity service is further operative to store the activity data in an activity store on the computer storage device. The end user computer comprises a network interface configured to connect the end user computer to the computer network, a computer storage device, and a processing device. The processing device executes computer program code that configures the end user computer to be comprising an end user application and a protocol component. The end user application is operative to edit electronic documents in the computer storage device. The protocol component is operative to receive activity data from the activity service of the server computer indicating activity data previously stored by the activity service in the activity store for the electronic document, and to purge the previously stored activity data from the activity data part of the electronic document.

In another aspect, a computer comprises a computer storage device and a processing device. The processing device executes computer program code that configures the computer to be comprising an end user application and a protocol component. The end user application is operative in response to user input to edit an electronic document in the computer storage device. The end user application is operative in response to user input to define activity data representing user actions related to the electronic document. The protocol component is operative to receive the activity data from the end user application, and to store the activity data in an activity data part of the electronic document, and to save the electronic document in a shared storage system. The protocol component is operative to access an activity service associated with the shared storage system providing previously stored activity data for the electronic document, and is operative to purge the previously stored activity data from the activity data part of the electronic document.

In another aspect, a computer comprises means for storing activity data in an activity data part of an electronic document, means for storing the electronic document with the activity data part as a data file in a shared storage system, means for accessing previously stored activity data from the shared storage system, and means for purging previously stored activity data from the activity data part of the electronic document.

In another aspect, a computer implemented process includes storing activity data in an activity data part of an electronic document, storing the electronic document with the activity data part as a data file in a shared storage system, accessing previously stored activity data from the shared storage system, and purging previously stored activity data from the activity data part of the electronic document.

In any of the foregoing aspects, the activity service can be operative in response to a request, with respect to an electronic document, from a protocol component on an end user computer to provide activity data for the electronic document to the protocol component.

In any of the foregoing aspects, the server computer can include a server-side activity component operative, in response to actions on electronic documents stored in data files of the file system, to provide activity data to the activity service about the actions for storage in the activity store.

In any of the foregoing aspects, the activity service can be operative, in response to requests from a protocol component on an end user computer, with respect to actions on electronic documents on the end user computer, to provide activity data to the activity service about the actions for storage in the activity store.

In any of the foregoing aspects, the protocol component can be operative to provide the activity data received from the activity service to the end user application a presentation in a graphical user interface.

In any of the foregoing aspects, the protocol component can be operative to coalesce activity data in the activity data part before saving the electronic document to the shared storage system.

In any of the foregoing aspects, the protocol component can be operative to purge the activity data in response to a request to save the electronic document to the shared storage system.

In any of the foregoing aspects, the shared storage system can be accessed by the protocol component comprises the activity service, and the activity service is operative to extract activity data from the activity data part of the electronic document.

In any of the foregoing aspects, the protocol component can be operative to periodically update previously stored activity data for an electronic document while the electronic document is open in the end user application.

In any of the foregoing aspects, an electronic document comprises data defining structure and content of the electronic document, data defining comments associated with the electronic document, and actions associated with the electronic document.

In any of the foregoing aspects, the actions can include data describing actions performed by users and associated with the electronic document.

In any of the foregoing aspects, the actions can include actions with respect to the electronic document. Such actions can include, but are not limited to, opening, saving or closing a document, sharing the document, and changing permissions of the document.

In any of the foregoing aspects, the actions can include actions with respect to comments in the electronic document. Such actions can include, but are not limited to, adding, editing or deleting a comment, replying to a comment, marking a comment as resolved, and marking a comment as unresolved.

In another aspect, an article of manufacture includes at least one computer storage medium, and computer program instructions stored on the at least one computer storage medium. The computer program instructions, when processed by a processing system of a computer, the processing system comprising one or more processing units and storage, configures the computer as set forth in any of the foregoing aspects and/or performs a process as set forth in any of the foregoing aspects.

Any of the foregoing aspects may be embodied as a computer system, as any individual component of such a computer system, as a process performed by such a computer system or any individual component of such a computer system, or as an article of manufacture including computer storage in which computer program instructions are stored and which, when processed by one or more computers, configure the one or more computers to provide such a computer system or any individual component of such a computer system.

It should be understood that the subject matter defined in the appended claims is not necessarily limited to the specific implementations described above. The specific implementations described above are disclosed as examples only.

What is claimed is:

1. A shared storage system, comprising:
a server computer comprising:
a network interface configured to connect the shared storage system to a computer network connected to a plurality of end user computers,
a computer storage device, and
a processing device;
the processing device executing computer program code that configures the server computer to be comprising:
a file system operative to provide access to a plurality of electronic documents in the computer storage device, and operative, in response to receiving an electronic document including an activity data part, to store the electronic document with the activity data part as a data file in the file system; and
an activity service operative to extract activity data from an activity data part of an electronic document, the activity data including, for an action performed on an end user computer, an identifier of the action, an identifier of a type of the action, and an identifier of an end user, the activity service further operative to store the activity data in an activity store on the computer storage device.

2. The shared storage system of claim 1 wherein the activity service is operative in response to a request, with respect to an electronic document, from a protocol component on an end user computer to provide activity data for the electronic document to the protocol component.

3. The shared storage system of claim 1 wherein the server computer further comprises a server-side activity component operative, in response to actions on electronic documents stored in data files of the file system, to provide activity data to the activity service about the actions for storage in the activity store.

4. The shared storage system of claim 1 wherein the activity service further is operative, in response to requests from a protocol component on an end user computer, with respect to actions on electronic documents on the end user computer, to provide activity data to the activity service about the actions for storage in the activity store.

5. A computer system, comprising:
a server computer comprising:
a network interface configured to connect the shared storage system to a computer network,
a computer storage device, and
a processing device, the processing device executing computer program code that configures the server computer to be comprising:
a file system operative to provide access to a plurality of electronic documents in the computer storage device, and operative, in response to receiving an electronic document including an activity data part, to store the electronic document with the activity data part as a data file in the file system; and
an activity service operative to extract the activity data from the activity data part of an electronic document, the activity data including, for an actions performed on an end user computer, an identifier of the action, an identifier of a type of the action, and an identifier of an end user, the activity service storing the activity data in an activity store.
an end user computer comprising:
a network interface configured to connect the end user computer to the computer network,
a computer storage device, and
a processing device;
the processing device executing computer program code that configures the end user computer to be comprising:
an end user application operative to edit electronic documents in the computer storage device, and
a protocol component, operative to receive activity data from the activity service of the server computer indicating activity data previously stored by the activity service in the activity store for the electronic document, and to purge the previously stored activity data from the activity data part of the electronic document.

6. The computer system of claim 5 wherein the activity service is operative in response to a request, with respect to an electronic document, from a protocol component on an end user computer to provide activity data for the electronic document to the protocol component.

7. The computer system of claim 5 wherein the server computer further comprises a server-side activity component operative, in response to actions on electronic documents stored in data files of the file system, to provide activity data to the activity service about the actions for storage in the activity store.

8. The computer system of claim 5 wherein the activity service further is operative, in response to requests from the protocol component on the end user computer, with respect to actions on electronic documents on the end user computer, to provide activity data to the activity service about the actions for storage in the activity store.

9. The computer system of claim 5, wherein the protocol component is further operative to provide the activity data received from the activity service to the end user application a presentation in a graphical user interface.

10. The computer system of claim 5, wherein the protocol component is further operative to coalesce activity data in the activity data part before saving the electronic document to the shared storage system.

11. The computer system of claim 5, wherein the protocol component is operative to purge the activity data in response to a request to save the electronic document to the shared storage system.

12. A computer comprising:
a computer storage device and a processing device;
the processing device executing computer program code that configures the computer to be comprising:
an end user application operative, in response to user input, to edit an electronic document in the computer storage device, and operative, in response to user input, to define activity data representing user actions related to the electronic document; and
a protocol component operative to receive the activity data from the end user application, and to store the activity data in an activity data part of the electronic document, and to save the electronic document in a shared storage system;
wherein the protocol component is operative to access an activity service associated with the shared storage system providing previously stored activity data for the electronic document, and is operative to purge the previously stored activity data from the activity data part of the electronic document.

13. The computer of claim 12, wherein the shared storage system accessed by the protocol component comprises the activity service, and the activity service is operative to extract activity data from the activity data part of the electronic document.

14. The computer of claim 12, wherein the activity service further is operative, in response to requests from the protocol component on the end user computer, with respect to actions on electronic documents on the end user computer, to provide activity data to the activity service about the actions for storage in the activity store.

15. The computer of claim 12, wherein the protocol component is further operative to provide the activity data received from the activity service to the end user application a presentation in a graphical user interface.

16. The computer of claim 12, wherein the protocol component is further operative to coalesce activity data in the activity data part before saving the electronic document to the shared storage system.

17. The computer of claim 12, wherein the protocol component is operative to purge the activity data in response to a request to save the electronic document to the shared storage system.

18. The computer of claim 12 wherein the protocol component is operative to periodically update the previously stored activity data for an electronic document while the electronic document is open in the end user application.
